(19) United States
(12) Patent Application Publication
(10) Pub. No.: US 2026/0076789 A1
(43) Pub. Date: Mar. 19, 2026

(54) ERGONOMIC ULTRASONIC DENTAL SCALING DEVICES

(71) Applicant: Paschke Ultrasonix LLC, Londonderry, NH (US)

(72) Inventor: Richard H. Paschke, Londonderry, NH (US)

(21) Appl. No.: 19/332,566

(22) Filed: Sep. 18, 2025

Related U.S. Application Data
(60) Provisional application No. 63/695,888, filed on Sep. 18, 2024.

(51) Int. Cl. A61C 17/20; A61C 1/00

(52) U.S. Cl. CPC A61C 17/20; A61C 1/0084

(57) ABSTRACT

An ergonomic ultrasonic dental scaling device includes an acoustic assembly including an acoustic transformer configured to detachably receive a tip and a transducer coupled to the acoustic transformer. The transducer includes at least two first contacts coupled thereto. A resilient grip is coupled to the acoustic assembly and configured to dampen ultrasonic vibrational acceleration produced by the transducer. At least two rotational conductors are configured to electrically couple the at least two first contacts with at least two second contacts configured to connect to an ultrasonic drive system. A fluid connection is rotatably coupled to the acoustic assembly. The resilient grip is configured to rotate the acoustic assembly relative to the fluid connection, the at least two second contacts, and a handpiece housing. A rotational interface of the rotation is located forward of a longitudinal center of the ergonomic ultrasonic dental scaling device.

### CROSS-REFERENCE TO RELATED APPLICATION

This application is related to U.S. patent application Ser. No. 18/106,799, filed Feb. 7, 2023, and published as Patent Application Pub. No. US 2023/0248496, the entire contents of which are hereby incorporated herein by reference. This application claims the benefit of, and priority to, U.S. Provisional Patent Application No. 63/695,888 , filed on Sep. 18, 2024, the entire contents of which are hereby incorporated herein by reference.

### BACKGROUND

### Technical Field

The present disclosure relates to ultrasonic dental devices and, more specifically, to an ultrasonic dental device with improved ergonomics having a handpiece with a piezo transducer that rotates 360 when mounted in the handpiece and a resilient grip that reduces Hand-Arm Vibration Syndrome (“HAVS”).

### Background of Related Art

One of the major challenges in ultrasonic scaling centers on the ergonomics of using scaler handpieces. The clinician in many instances is required to use poor body position and wrist positions during treatment. Potential injury occurs whenever the orientation of the insert or tip does not allow the clinician to maintain a neutral wrist position during tip adaptation as required during treatment. In addition, even the task of readjusting the fluid flow during treatment can result in the clinician contorting their body.

In conventional dental handpieces, the drive cable or hose may transmit torsional forces to the handpiece body during use. This resistive torque can require the operator to exert counter-rotational forces with the hand and wrist, particularly during procedures of extended duration. Such repetitive compensatory motion can increase operator fatigue and may contribute to musculoskeletal strain.

Hand-Arm Vibration Syndrome (“HAVS”) is an occupational condition caused by prolonged exposure to vibration from hand-held tools. HAVS is expressed as the vibration acceleration of the tool (in m/s², measured per ISO 5349) over a period of time. A HAVS exposure limit may be, for example, 2.5 m/s² A(8), representing the daily 8-hour time-weighted acceleration that triggers the duty to take action: risk assessment, health surveillance, training, and measures to reduce vibration.

Magnetostriction and piezoelectric, often abbreviated as magneto and piezo, are two ultrasonic technologies currently used in dental scaling. Magneto systems use inserts that are detachable by means of insertion and extraction into a handpiece designed to receive the insert. The inserts and handpieces in such magneto systems allow the inserts to rotate 360 degrees which allow positioning of the inserts prior to treatment.

Piezo handpieces, on the other hand, have screw in tips that result in the final connection points of the tips at fixed arbitrary angles relative to the handpieces and the zero torque position of the handpiece cable. This requires the clinician to rotate the handpiece to a position that allows adaptation of the tip to the tooth being treated. This forces the clinician to maintain a grip of the piezo handpiece under a non-zero cable torque throughout the treatment. Further, rotating the insert around the tooth angle during continued treatment results in increased torque.

The Cavitron ultrasonic systems, circa 1986, were operating at 25 kHz. The industry complaint was that the handpieces were too long and cumbersome. Cavitron Corporation, which is now a part of DENTSPLY/SIRONA, introduced a 30 kHz system called the model 3000 which featured a compact, sterilizable handpiece operating at 30 kHz, called the Sterimate®. This addressed the size of the handpieces but there was still an issue with the problem of cable toque during treatment.

Hu-Friedy was the first company to address the cable toque with a rotating insert (see U.S. Pat. No. 6,716,028), which was an instant success but some early inserts suffered from water leakage at the swivel joint. Current product seems to have remedied the problem but at the expense of increased rotational torque. Zila patented a swivel insert (see U.S. Pat. No. 8,435,034), which addressed the cable torque to some degree, but it was not universally accepted due to its limited reduction in torque and propensity of the insert to eject from the handpiece during rotation with nominal water pressures in the handpiece.

Magneto inserts position their transducers at the rear of the assembly and operate by exciting the insert with an alternating magnetic field. Such devices do not require direct electrical conductors into the oscillating body and do not require fluid conduits in line with the transducer assembly. By contrast, piezoelectric handpieces employ a stack of piezoelectric crystals sandwiched between a load mass and an acoustic transformer. This architecture requires direct electrical connections to the crystal stack, as well as accommodations to seal fluid passages. These constraints establish a fundamental challenge to including a rotational interface without disrupting operability. Unlike magneto devices, piezoelectric designs cannot be easily modified to correct these complexities without substantial redesign. By way of this example, what is feasible in a magnetostrictive assembly is not feasible in a piezoelectric assembly.

Magneto inserts have the ability to rotate in the handpiece albeit with large torque values. Typically, piezo transducers are permanently mounted within the handpiece and are therefore not removable by the end user. Only the handpiece assemblies are detachable from the cable assemblies. Traditionally, the piezo electrical connections and water conduit requirements prohibited rotation of the handpieces. Some companies have introduced handpiece cable assemblies that have limited rotation capabilities; however, they fall short of substantially removing the cable torque. In addition, they are expensive and may not provide consistent connection to the dental handpieces.

Dentsply described a rotatable piezo handpiece (see U.S. Pat. No. 10,575,592), which provided a rotational element. However, it represented a step backwards in that it required a fragile ferrite component and added additional weight to the handpiece. A cylindrical transformer as described in FIG. 9 of U.S. Pat. No. 10,575,592 would add a minimum of 6-8 grams of weight to the handpiece, not including any required encapsulants to provide moisture protection. In addition, the point of rotation is at the back of the handpiece cable connection, which is identical to currently available mechanical swivels incorporated in the handpiece cable plugs but at an additional cost and complexity. In addition, the constraint of having the ferrite transformer located behind the loading mass precludes moving the point of rotation frontward along the handpiece assembly as relocating the rotational interface frontward would physically interfere with the transducer elements and would disrupt the operability of the handpiece.

In addition, ferrites have a reputation for being fragile as evidenced by the Odontoson M, an ultrasonic scaler that featured a sintered ferrite stack, which was prone to accidental breakage during handling. The ferrite core of the primary transformer in the Dentsply design would be exposed whenever the handpiece was not connected to the cable assembly, for example, when the handpiece was being sterilized (see U.S. Pat. No. 10,575,592). Accidental dropping of the handpiece would most likely result in the fracture of the fragile ferrite core located in the handpiece.

### SUMMARY

The terms “about,” substantially,” and the like, as utilized herein, are meant to account for manufacturing, material, environmental, use, and/or measurement tolerances and variations. Further, to the extent consistent, any of the aspects described herein may be used in conjunction with any or all the other aspects described herein. The terms amplitude and stroke are utilized interchangeably with reference to output levels of a device.

The terms “ultrasonic energy,” “ultrasonic wave,” “vibrational wave,” and like terms are used interchangeably to describe vibratory motion at ultrasonic frequencies, namely frequencies greater than approximately 18 kHz. In the context of the present disclosure, these terms encompass both mechanical oscillations of a transducer assembly, acoustic propagation through an acoustic transformer or tool tip, and transmission through a fluid medium when applicable. Unless otherwise specified, these terms are not intended to be limited to a particular propagation mode or medium, but rather refer generally to the vibrational phenomena generated by the transducer assembly and coupled through the handpiece.

Provided in accordance with this disclosure is an ergonomic ultrasonic dental scaling device incorporating a rotational coupling that permits substantially 360 degrees of relative rotation between the cable and the handpiece assembly. The rotatable coupling allows the handpiece assembly to rotate freely thereby minimizing any transmitted cable torque to the operator's hand such that torsional resistance at the hand-tool interface is substantially reduced.

By minimizing transmitted torque, the ergonomic ultrasound dental scaling device of the present disclosure facilitates maintenance of a neutral wrist posture and reduces the biomechanical load on the operator's hand, wrist, and forearm. These ergonomic improvements address occupational risk factors associated with repetitive strain injuries in dental practitioners. The reduction of cable torque also assists in mitigating operator discomfort linked to musculoskeletal conditions such as, by way of example, carpal tunnel syndrome.

In accordance with the present disclosure, an ergonomic ultrasonic dental scaling device is provided which overcomes the above-noted limitations and challenges and incorporates, into a handpiece assembly of the system, a transducer for generating ultrasonic energy and an acoustic transformer for coupling the ultrasonic energy waves to a working tool or tip. The handpiece is fully detachable and rotatable and thereby reduces cord-related torque, wherein the tortional resistance applied to the user's hand is reduced during operation.

This also addresses the ergonomic issues by providing a shorter length than current piezo handpieces without adding unnecessary weight or sacrificing a robust construction.

In accordance with the present disclosure, an ergonomic ultrasonic dental scaling device is provided with a resilient grip which reduces vibrational acceleration associated with HAVS.

Various aspects and features of the present disclosure are provided below. Other aspects and features are described throughout this disclosure.

In aspects, an ergonomic ultrasonic dental scaling device is provided including an acoustic assembly having an acoustic transformer configured to detachably receive a tip and a transducer coupled to the acoustic transformer and configured to produce ultrasonic vibrational energy (e.g., based on a drive signal provided by a signal source such as an ultrasonic drive system). The transducer includes at least two first contacts coupled thereto. A resilient grip having a substantially uniform cross-sectional configuration is coupled to the acoustic assembly and configured to dampen the ultrasonic vibrational energy produced by the transducer. At least two rotational conductors are configured to electrically couple the at least two first contacts with at least two second contacts configured to connect to the signal source (e.g., an ultrasonic drive system). A fluid connection is rotatably coupled to the acoustic assembly. The resilient grip is configured to rotate the acoustic assembly relative to the fluid connection, the at least two second contacts, and a handpiece housing. A rotational interface of the rotation is located forward of a longitudinal center of the ergonomic ultrasonic dental scaling device such that the tortional resistance applied to the user's hand is reduced during operation.

In aspects, the transducer is configured to generate vibrational waves with an amplitude component between 0.2 and 5.0 mils. In aspects, the transducer is powered by an ultrasonic control circuit (e.g., of the ultrasonic drive system).

In aspects, the acoustic assembly (including the transducer assembly and the acoustic transformer, which together define a piezo driver) is disposed within an inner housing (e.g., that encloses the piezo driver). The inner housing (and piezo driver therein) is rotatable when mounted in the handpiece housing, as herein described.

In aspects, an ergonomic ultrasonic dental scaling device is provided including an acoustic assembly having an acoustic transformer configured to detachably receive a tip and a transducer coupled to the acoustic transformer and configured to produce ultrasonic vibrational energy. A resilient grip is coupled to the acoustic assembly. The resilient grip has a substantially uniform cross-sectional configuration and/or comprises an elastomeric sleeve having a Shore A durometer hardness from about 40 to about 60. The resilient grip is positioned coaxially about the transducer and is configured to reduce measured vibration acceleration at the grip surface by a factor of at least 2:1 relative to a rigid grip of similar geometry when tested according to ISO 5349-1 methodology. At least two rotational conductors are configured to electrically couple the transducer to an ultrasonic drive system. A fluid interface rotatably couples to the acoustic assembly. A combination of the tip, the resilient grip, and the acoustic assembly are configured to rotate about an assembly axis relative to a handpiece housing while maintaining the electrical coupling between the transducer and the ultrasonic drive signal and the coupling between the fluid interface and the acoustic assembly.

In aspects, an ergonomic ultrasonic dental scaling device is provided including an assembly including an acoustic transformer configured to detachably receive a tip and a transducer coupled to the acoustic transformer and configured to produce ultrasonic vibrational energy. A fluid reservoir is configured to contain at least about 50 milliliters of fluid. A spring-loaded reservoir cap is configured to maintain a relatively uniform pressure on the fluid contained in the reservoir. A solenoid is operably coupled to the reservoir and configured to provide on-off control of fluid delivery. A resilient grip is coupled to the acoustic assembly. The resilient grip has a substantially uniform cross-sectional configuration and/or comprises an elastomeric sleeve having a Shore A durometer hardness of from about 40 to about 60. The resilient grip is positioned coaxially about the transducer and is configured to reduce measured vibration acceleration at the grip surface by a factor of at least 2:1 relative to a rigid grip of similar geometry when tested according to ISO 5349-1 methodology. At least two rotational conductors are configured to electrically couple the transducer to an ultrasonic drive signal, e.g., of an ultrasonic drive system. A fluid interface rotatably couples to the acoustic assembly. A combination of the tip, the resilient grip, and the acoustic assembly is configured to rotate about a common axis relative to a handpiece housing. The rotational interface of the rotation is located forward of a longitudinal center of the ergonomic ultrasonic dental scaling device.

In aspects, any of the ergonomic ultrasonic dental scaling device of this disclosure may provide coolant flow to the working tool (tip) and minimize the amount of coolant required by controlling the feed rate of the coolant under pressure. The feed rate may be determined by the level of tool amplitude during treatment. That is, the output flow rate is controlled based upon the output amplitude, e.g., based on a feedback loop wherein the output amplitude of the ultrasonic drive is fed from the ultrasonic control circuit (e.g., of the ultrasonic drive system) to a fluid control circuit to control the solenoid or other flow controller for controlling the feed rate of the coolant under pressure. In aspects, the coolant flow is proportional to the amplitude. In this manner, the total amount of coolant volume required during treatment is minimized without affecting the coolant efficiency, thereby providing a hands-free operation, and increasing the ergonomics of the device during treatment.

In aspects, at least two rotational conductors establish rotational electrical connections between the rotating portion and the non-rotating portion of the device. These rotational conductors, in aspects, may include a series of conductive rings concentrically arranged and of different diameters (for at least two of the rings). At least one conductive ring may couple a signal source on the non-rotating side to one or more light emitting diodes (LEDs) or other suitable illumination device(s) on the rotating side to illuminate a field of view during treatment. The input signal for the LED series, in aspects, may be a low voltage power signal from a low voltage power source capable of lighting the LED light source.

Any of the ergonomic ultrasonic dental scaling device of this disclosure may be configured to allow for a minimum of 360-degree rotation to improve adaptation to tooth line angles. Such rotation may be provided at torques less than 5 in/oz.

The ergonomic ultrasonic dental scaling devices of the present disclosure may be configured for use with either “E” type or “S” type tips currently available in the marketplace.

In another exemplary aspect, wherein the fluid interface is configured to couple a pressurized water supply to the tool or tip for cooling during operation.

In another exemplary aspect the at least two conductors are configured to provide electrical coupling while permitting continuous 360-degree rotation of the transducer relative to the handpiece housing.

In a further aspect, a rotatable connection, comprising a series of concentric rings is in electrical communication with a signal source configured to produce a signal for the acoustic assembly to generate a vibrational wave.

In another exemplary aspect, the rotational interface comprises a bearing assembly configured to permit substantially frictionless rotation.

In another exemplary aspect, a fluid reservoir configured to contain at least about 50 milliliters of fluid is provided within the handpiece housing. A spring-loaded reservoir cap coupled, e.g., threaded to, the handpiece housing retains the fluid reservoir within the handpiece housing and maintains a relatively uniform pressure on the fluid contained in the reservoir. A solenoid operatively coupled to the reservoir is configured to provide on-off control of fluid delivery. Fluid flow may be controlled at intermittent rates, e.g., by the solenoid or other flow controller, based on the output tip amplitude, thereby eliminating user intervention during treatment.

Other features, objects, and advantages of the devices and techniques described in this disclosure will be apparent from the description and drawings.

### BRIEF DESCRIPTION OF THE DRAWINGS

FIG. 1 is a side view of an ergonomic piezo ultrasonic dental scaling device provided in accordance with the present disclosure, where the axis and horizontal point of handpiece rotation are illustrated;

FIG. 2 is a cross-sectional side view of a handpiece assembly of the ergonomic piezo ultrasonic dental scaling device of FIG. 1;

FIG. 3 is side view of an acoustic assembly of the ergonomic piezo ultrasonic dental scaling device of FIG. 1;

FIG. 4 is an exploded, perspective view of the ergonomic piezo ultrasonic dental scaling device of FIG. 1 with the tip removed;

FIG. 5 is an exploded, perspective view of the acoustic assembly of the handpiece assembly of the ergonomic piezo ultrasonic dental scaling device of FIG. 1;

FIG. 6 depicts a screening test setup measuring acceleration of the acoustic vibrations (HAVS) of the ergonomic piezo ultrasonic dental scaling device of FIG. 1 under a dental load against an enamel surface of a tooth;

FIG. 7 is a perspective view of a rotating acoustic assembly configured for use with an ergonomic piezo ultrasonic dental scaling device in accordance with this disclosure for rotatably coupling a detachable cable assembly to a series of concentric, conductive rings configured to transfer signals from an ultrasonic driver system; and

FIG. 8 is a side, partial cut-away view of another ergonomic piezo ultrasonic dental scaling device in accordance with the present disclosure including an integral fluid reservoir.

### DETAILED DESCRIPTION

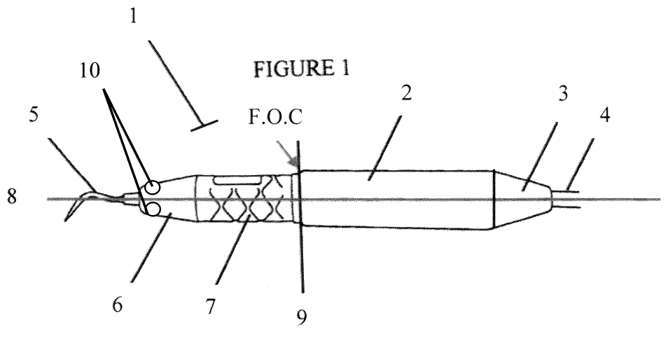

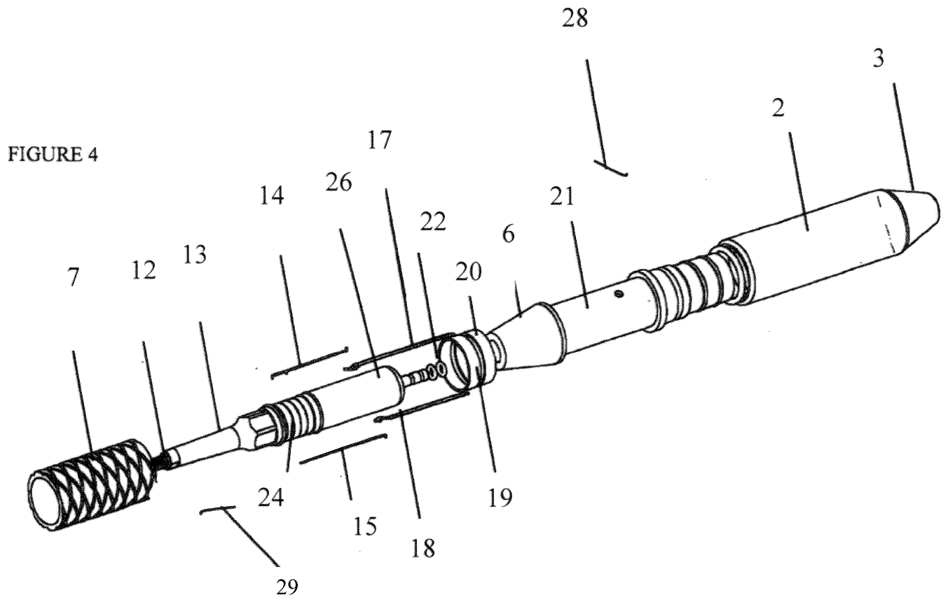

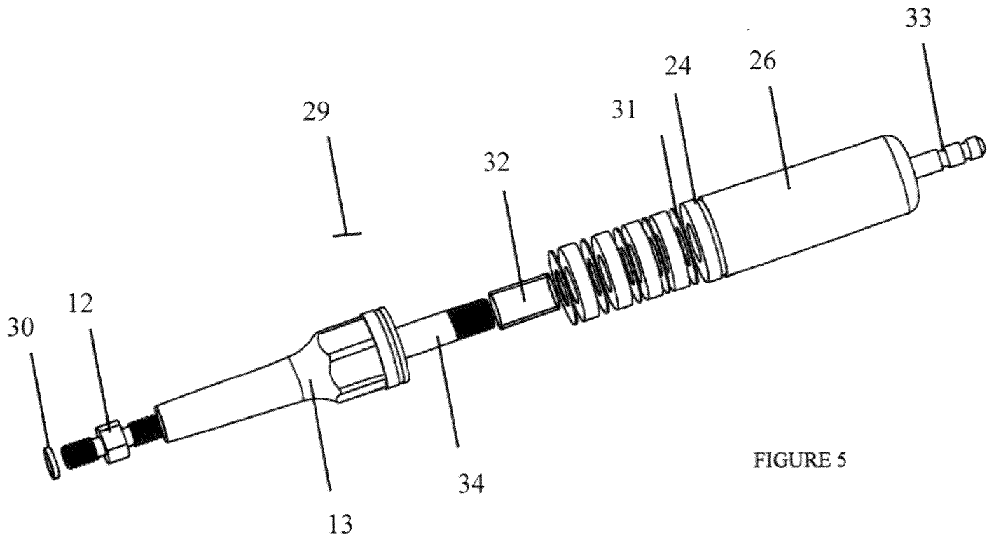

Referring to FIG. 1, an ergonomic piezo ultrasonic dental device provided in accordance with the present disclosure is shown generally identified by reference numeral 1. The device 1 includes a resilient grip 7 and a rear handpiece housing 2. Resilient grip 7 provides ergonomic comfort for grasping and facilitating rotation of the handpiece assembly 28 (FIG. 4) of device 1 over an angle of greater than 360 degrees, about longitudinal axis 8 of device 1, relative to rear handpiece housing 2 and the cable connector 3 and handpiece cable 4 that are non-rotatably connected to rear the handpiece housing 2. Additionally, the resilient grip 7 is coupled to the acoustic assembly 29 (FIG. 5) of the handpiece assembly 28 (FIG. 4) of the device 1 and is configured to dampen vibrational acceleration generated by the acoustic assembly 29 (FIG. 5). The resilient grip 7 may comprise an elastomeric sleeve having a Shore A durometer hardness of from about 40 to about 60 and is positioned coaxially about the transducer. The resilient grip 7 is configured to reduce measured vibration acceleration at the grip surface by a factor of at least 2:1 relative to a rigid grip of similar geometry (including a rigid grip of identical geometry) when tested according to ISO 5349-1 methodology. In aspects, the resilient grip 7 defines a substantially uniform cross-sectional configuration along its length. In aspects, the resilient grip 7 defines an outer diameter of from about 10 mm to about 18 mm to facilitate ergonomic handling by a user. In aspects, the resilient grip includes layered elastomeric zones, e.g., concentric elastomeric layers, of varying durometer hardness, e.g., within the Shore A durometer hardness range of from about 40 to about 60 or defining an overall Shore A durometer hardness range of from about 40 to about 60) to enhance vibration damping. The elastomeric material, in aspects, may be silicone, thermoplastic elastomer (TPE), or polyurethane (or combinations thereof in layers, for example).

The distal portion of the device 1 has a tapered nose cone 6 that provides an unobscured view of the treatment site during use and, in some aspects, is removable. In additional or alternative aspects, tapered nose cone 6 may contains one or more LEDs 10 or other suitable light sources to illuminate the treatment site. A working tool or tip 5 is coupled to the acoustic assembly 29 (FIG. 5), e.g., via threaded connection, and extends from tapered nose cone 6. In aspects, the one or more LEDs 10 illuminate a volume surrounding the working tool 5. In accordance with this disclosure, a rotational interface 9, e.g., between the handpiece assembly 28 (FIG. 4) and rear handpiece housing 2, is located forward of a longitudinal center of the device 1. Interface 9 is depicted as F.O.C., which denotes front of center.

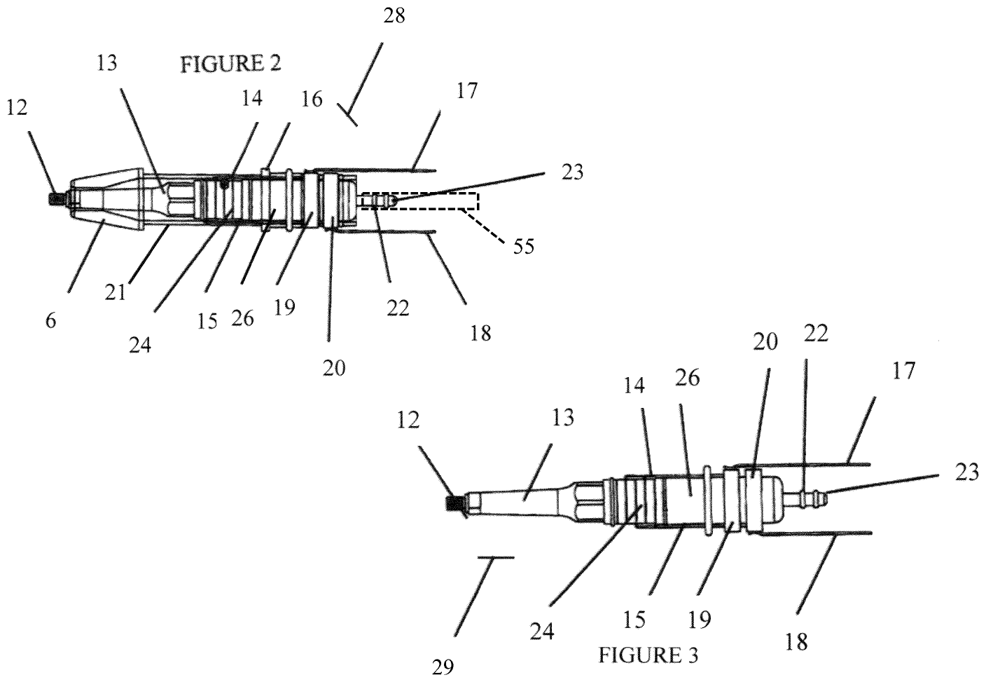

Referring to FIGS. 2 and 3, a cross-sectional, side view of the handpiece assembly 28 (which includes the acoustic assembly 29 (FIG. 3)) is shown illustrating the inner housing 21 of the handpiece assembly 28 at least partially enclosing an acoustic transformer 13, a stack of piezoelectric crystals 24, and a loading mass 26 of the acoustic assembly 29 of the handpiece assembly 28. The tapered nose cone 6 of the handpiece assembly 28 may be integrally formed with the inner housing 21 or otherwise attached thereto in fixed engagement and to provide a direct view during treatment. Threaded connector 12 is disposed at a distal end of the acoustic transformer 13 and extends from tapered nose cone 6 to enable threaded receipt of a detachable tip, e.g., tip 5 (FIG. 1). The threaded connector 12 for the detachably connectable tip 5 (FIG. 1) is in mechanical communication with the acoustic transformer 13 such that, upon attachment of the tip 5 (FIG. 1), the tip 5 (FIG. 1) is in mechanical communication with the acoustic transformer 13 to receive ultrasonic vibration energy waves therefrom.

The acoustic transformer 13 maintains connection to the stack of piezoelectric crystals 24, and the loading mass 26, under compression. The inner housing 21 and nose cone 6 cooperate to encloses the acoustic assembly 29 except for, in aspects, at least a portion of the threaded connector 12, and provide support for the rotational conductors 19 and 20 of the handpiece assembly 28. A high frequency (HF) signal contact 17 and a ground signal contact 18 coupled with respective electrical leads extending through the rear handpiece housing 2 and cable 4 (FIG. 1) to connect to an ultrasonic driver system are electrically connected to the rotational conductors 19 and 20, respectively, for transferring electrical signals to respective rotational conductors 19 and 20 of the handpiece assembly 28, which, in turn, are in electrical communication with positive (+) and negative (−) crystal leads 14 and 15, respectively. Crystal leads 14, 15 are disposed between the crystals of the stack of piezoelectric crystals 24 such that the stack of piezoelectric crystals 24 produces ultrasonic vibration energy waves in response to application of an HF signal thereto. Rotational conductors 19 and 20 maintain electrical communication between crystal leads 14, 15 of handpiece assembly 28 and respective contacts 17, 18 extending through rear handpiece housing 2 regardless of the rotational orientation of handpiece assembly 28 relative to rear handpiece housing 2, thus enabling the above-noted rotation angle of greater than 360 degrees while maintaining electrical communication.

The mesial end 23 of the loading mass 26 provides rotational connection to a fluid source (see, e.g., fluid source 52 (FIG. 8)) wherein one or more O-rings 22, which may comprise two O-rings as shown herein or in another aspect be a single O-ring, facilitate formation of a fluid-tight seal with a fluid supply conduit 55 disposed about the mesial end 23 of the loading mass 26. This fluid interface is configured to couple a pressurized water supply via fluid supply conduit 55 to enable the delivery of fluid through an internal channel defined through the acoustic assembly 29 (FIG. 5) and to the tool or tip 5 for cooling during operation while providing rotational stability and fluid integrity. Rotational interface 16 of the handpiece assembly 28 may comprise a bearing assembly or other suitable rotational interface between the handpiece assembly 28 and handpiece housing 2 configured to permit substantially frictionless rotation of the handpiece assembly 28 at least partially within and relative to rear handpiece housing 2.

FIG. 4 shows an exploded view of the device 1 and its components including the handpiece assembly 28 (and acoustic assembly 29 thereof) and the rear handpiece housing 2. The distal end of the acoustic assembly 29, as noted above, contains a threaded connector 12 that determines the type of threads that interface with a working tool, e.g., tip 5 (FIG. 1).

With additional reference to FIG. 5, acoustic transformer 13, prestress post 34, insulator 32, and loading mass 26 of acoustic assembly 29 in combination provide prestress for the piezo transducer crystals of the stack 24, and ring conductors 31 disposed between the piezo crystals of the stack 24 to provide electrical contacts for the crystals of the stack 24, acoustic transformer 13, and loading mass 26 to generate ultrasonic vibration energy in response to application of the drive signal (voltage) to the crystals of the stack 24. Prestress post 34 may be threaded into engagement with loading mass 26 to retain the stack of crystals 24 therebetween under prestress. The stack of crystals 24 define a piezoelectric ultrasonic transducer themselves or, in aspects, in combination with loading mass 26, which is threaded to acoustic transformer 13 via prestress post 34 to maintain the stack of crystals 24 between loading mass 26 and acoustic transformer 13 under prestress compression. Insulator 32 maintains ring conductors 31 in an electrically isolated configuration to inhibit short circuiting.

In aspects, plural threaded connectors 12 may be provided functioning as adaptors to enable use of both “E” type and “S” type tips, as currently available in the marketplace, with the device 1. More specifically, each threaded assembly 12 includes a first threaded interface on a first end thereof for engagement with acoustic transformer 13 and a second threaded interface on a second, opposite end thereof for engagement with a particular type of working tool or tip 5 (FIG. 1), e.g., an “E” type or “S” type tip. (See also FIG. 5).

As noted above, the resilient grip 7 is disposed about, e.g., in fixed relation with, the inner housing 21 and is constructed to reduce hand-arm vibration exposure such that transmitted vibration amplitude is diminished by a factor of at least about 2:1, e.g., relative to a conventional grip.

Electrical contacts 14 and 15, in combination with conductive rings 19 and 20, are configured to provide a high frequency signal, e.g., 18 to 32 kHz, to the stack of piezo crystals 24 in any rotational orientation of the handpiece assembly 28 relative to the handpiece housing 2. The acoustic assembly 29, as detailed above, maintains the piezoelectric crystals of the stack 24 under compressive force between the loading mass 26 and the acoustic transformer 13 to enable the ultrasonic vibrational waves to be produced upon application of the high frequency signal.

In aspects, the combination of the tool 5, resilient grip 7, and acoustic assembly 29 (e.g., the acoustic transformer 13, the stack of crystals 44, and the loading mass 26) are configured to freely rotate about a common longitudinal axis 8 (FIG. 1) relative to a handpiece housing 2 and with respect to a rotational interface 9 (FIG. 1) that is located forward of a longitudinal center of the device 1.

O-ring glands 33 shown in FIG. 5 are configured to seat the one or more O-rings 22 (FIG. 2).

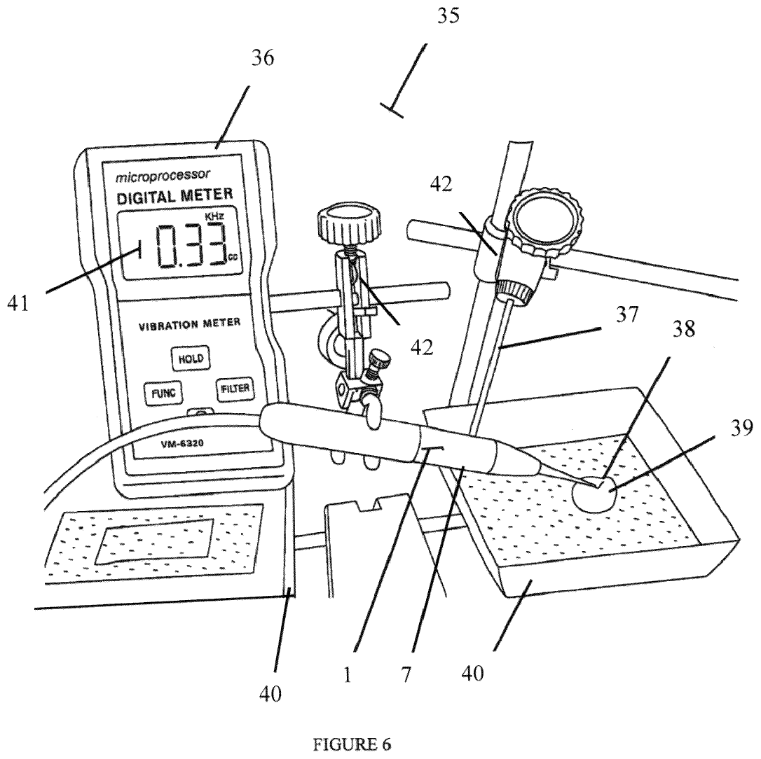

FIG. 6 details a screening test setup 35 measuring in-vitro vibrational acceleration, for example, to determine HAVS levels. The device 1 of this disclosure is shown engaged to and supported by a test stand 42, providing a stable force at the point 38 of the tip against the tooth surface 39. Balance scale 40 provides a calibrated load of the scale to the tool tip 38. Digital Velocity meter 36 displays an acceleration value 41 in m/sec², which corresponds to a one-dimensional HAVS value. It is noteworthy that diminished transmitted vibration acceleration or HAVS (as measured in m/sec²) must be realized during operation of the dental device under normal dental treatment loads and power setting appropriate for the attached tool, for example 5 to 25 grams at midpoint power setting. The acceleration value 41 is significantly diminished by the resilient grip 7 of device 1. That is, the resilient grip 7 reduces hand-arm vibration exposure such that transmitted vibration amplitude is diminished by a factor of at least about 2:1 relative to a conventional grip.

A series of five (5) screening measurements of HAVS of a conventional piezo ultrasonic dental device of similar geometry and with a rigid, non-uniform cross-section grip demonstrated that the vibrational values increased by a factor between 2:1 and 4:1 when the tip was loaded against a tooth surface with a force of 20 g. Using the test setup shown in FIG. 6, the measured screening values of the perpendicular component of acceleration were 0.85, 0.99, 1.05, 1.27, and 1.48 m/sec². The device 1 of this disclosure, in contrast, provided values reducing the perpendicular component of acceleration by at least about 2:1 and, in aspects, from about 2:1 to about 4:1. It is noted that HAVS values in piezo devices increase when the angle of adaptation of the tip relative to the tooth surface is increased from 0 to 30 degrees.

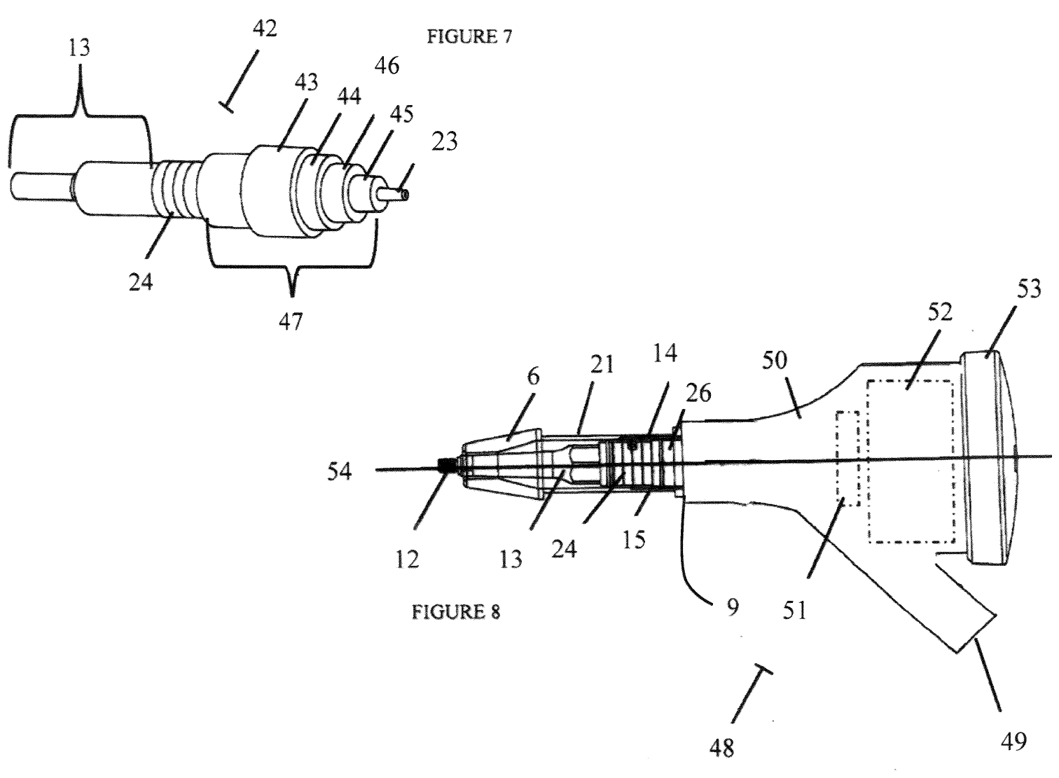

FIG. 7 is a perspective view of an alternate handpiece assembly 42 provided in accordance with this disclosure, wherein the acoustic assembly, e.g., the acoustic transformer 13, stack of crystals 24, and loading mass 26 (see FIG. 2) are configured to rotate freely relative to and at least partially within a rear handpiece housing 2 (FIGS. 1 and 4). A rotatable connection 47 of handpiece assembly 42 includes a series of concentric rings 43-46, e.g., four concentric rings defining rotational interfaces to enable electrical communication between a series, e.g., four, contacts coupled to the ultrasonic drive system (or other handpiece housing-side component) and a corresponding series, e.g., four, contacts coupled to the acoustic assembly in any rotational orientation of the handpiece assembly 42 relative to the rear handpiece housing 2 (FIGS. 1 and 4). In aspects, the concentric rings define different diameters, thus facilitating connection of a series, e.g., four, sets of contacts thereto. For purposes of simplification, the electrical connections coupled by the concentric rings 43-46 are not shown or repeated here as similar such contacts are detailed above. The mesial end 23 of the loading mass 26 (FIG. 2) provides rotational connection to the fluid source, similarly as detailed above. This fluid interface is configured to couple a pressurized water supply to the tool or tip for cooling during operation while providing rotational stability and fluid integrity.

FIG. 8 is a partially cut-away view of another ergonomic piezo ultrasonic dental scaling device in accordance with this disclosure similar to and including all of the features of device 1 (FIG. 1) and further including an integral fluid system 48. A fluid reservoir 52 configured to contain at least about 50 milliliters of fluid contains a spring-loaded reservoir cap 53 to retain the fluid reservoir 52 within the rear handpiece housing and to maintain a relatively uniform pressure on the fluid contained in the reservoir 52. A solenoid 51 is operatively coupled to the reservoir 52 and is configured to provide on-off control of fluid delivery. Thus, the device of FIG. 8 is capable of delivering fluid flows at an intermittent rate based on the output tip amplitude, thereby eliminating user intervention during treatment and eliminating the need for the clinician to contort their body to readjust the fluid flow More specifically, the solenoid 51 may be electronically coupled to the signal source such that fluid delivery is synchronized with the vibrational amplitude of the transducer, automatically adapting fluid delivery to changes in the vibrational amplitude proportionally. The device of FIG. 8, in addition to fluid system 48, includes acoustic transformer 13 and piezo transducer including a stack of piezo crystals 24 that, in combination, generate waves of ultrasonic vibration energy in response to application of a drive voltage, at handpiece cable connector input point 49, to the stack of piezo crystals 24. Threaded element 12 provides detachable connection with a tool, e.g., tool 5 (FIG. 1). A resilient grip 7 (FIG. 1) facilitates rotation of the inner housing 21 about a longitudinal axis 54 with rotational interface 9 located forward of the horizontal center of the device of FIG. 8.

Further aspects and features of the present disclosure are detailed in the following numbered paragraphs:
1. An ergonomic ultrasonic dental scaling device, comprising: an acoustic assembly including an acoustic transformer configured to detachably receive a tip and a transducer coupled to the acoustic transformer and configured to produce ultrasonic vibrational energy; and a resilient grip having a substantially uniform cross-sectional configuration, wherein the resilient grip includes an elastomeric sleeve having a Shore A durometer hardness of from about 40 to about 60, the resilient grip positioned coaxially about the transducer and configured to reduce measured vibration acceleration at a grip surface of the resilient grip by a factor of at least about 2:1 relative to a rigid grip of similar geometry when tested according to ISO 5349-1 methodology, wherein the resilient grip is configured to rotate the acoustic assembly relative to a handpiece housing.
2. The device according to paragraph 1, wherein at least two rotational conductors are configured to electrically couple the transducer with an ultrasonic signal source.
3. The device according to paragraph 2, wherein the at least two rotational conductors electrically connect at least two first contacts of the transducer with at least two second contacts configured to connect to the ultrasonic signal source.
4. The device according to paragraph 3, wherein the resilient grip is configured to rotate the acoustic assembly relative to the at least two second contacts.
5. The device according to any preceding paragraph, further comprising a fluid connection rotatably coupled to the acoustic assembly.
6. The device according to paragraph 5, wherein the resilient grip is configured to rotate the acoustic assembly relative to the fluid connection.
7. The device according to any preceding paragraph, wherein a rotational interface of the rotation is located forward of a longitudinal center of the ergonomic ultrasonic dental scaling device.
8. The device according to any preceding paragraph, wherein tortional resistance applied to a user's hand is reduced during operation of the ergonomic ultrasonic dental scaling device.
9. The device according to any preceding paragraph, wherein a combination of the tip, the resilient grip, and the acoustic assembly are configured to rotate about an assembly axis relative to the handpiece housing while maintaining electrical coupling between the transducer and an ultrasonic drive system and/or between a fluid interface and the acoustic assembly.
10. The device according to any preceding paragraph, further comprising: a fluid reservoir disposed within the handpiece housing; a spring-loaded reservoir cap configured to maintain a relatively uniform pressure on the fluid contained in the fluid reservoir; and a solenoid operably coupled to the fluid reservoir and configured to provide on-off control of fluid delivery, wherein the solenoid is electronically coupled to the ultrasonic signal source such that fluid delivery from the fluid reservoir is synchronized with a vibrational amplitude of the transducer.
11. The device according to paragraph 10, wherein the spring-loaded reservoir cap includes an elastomeric seal configured to prevent leakage during pressurization.
12. The device according to paragraph 10 or 11, wherein the solenoid is configured to operate at a DC voltage of from about 12 volts to about 24 volts.
13. The device according to any preceding paragraph, wherein the acoustic assembly further comprises a preload mechanism configured to maintain a stack of piezoelectric crystals of the transducer under compressive force between a loading mass and the acoustic transformer.
14. The device according to any preceding paragraph, wherein the resilient grip is configured to rotate the acoustic assembly at least 360 degrees relative to the handpiece housing.
15. The device according to any preceding paragraph, wherein at least four rotational conductors are configured to electrically couple the transducer with an ultrasonic signal source.
16. The device according to paragraph 2 or 15, wherein at least some of the rotational conductors are configured as concentric rings of different diameter.
17. The device according to any preceding paragraph, wherein a rotational interface of the rotation is located at an approximate midline of the handpiece housing.
18. The device according to paragraph 17, wherein the rotational interface includes a bearing assembly configured to permit substantially frictionless rotation.
19. The device according to any preceding paragraph, wherein a fluid interface is configured to couple a pressurized water supply to the tip for cooling during operation.
20. The device according to any preceding paragraph, wherein the resilient grip has an outer diameter of from about 10 mm to about 18 mm to facilitate ergonomic handling by a user.
21. The device according to any preceding paragraph, wherein the resilient grip comprises layered elastomeric zones of varying durometer hardness to enhance vibration damping.
22. The device according to any preceding paragraph, wherein the acoustic assembly further comprises a preload mechanism configured to maintain a stack of piezoelectric crystals of the transducer under compressive force between a loading mass and the acoustic transformer.
23. The device according to any preceding paragraph, wherein the resilient grip includes an elastomeric material, wherein the elastomeric material is silicone, thermoplastic elastomer (TPE), or polyurethane.
24. The device according to any preceding paragraph, wherein the resilient grip comprises layered elastomeric zones of varying durometer hardness to enhance vibration damping.
25. The device according to any preceding paragraph, wherein the resilient grip area is configured to reduce hand-arm vibration exposure such that transmitted vibration acceleration from the acoustic assembly to a user is diminished by a factor of from about 2:1 to about 4:1.

While several aspects of this disclosure are detailed above and shown in the drawings, it is not intended that this disclosure be limited thereto, as it is intended that the disclosure be as broad in scope as the art will allow and that the specification be read likewise. Therefore, the above description should not be construed as limiting, but merely as exemplifications of particular aspects.

What is claimed is:

1. An ergonomic ultrasonic dental scaling device, comprising:
an acoustic assembly including an acoustic transformer configured to detachably receive a tip and a transducer coupled to the acoustic transformer and configured to produce ultrasonic vibrational energy, the transducer including at least two first contacts coupled thereto;
a resilient grip having a substantially uniform cross-sectional configuration, wherein the resilient grip includes an elastomeric sleeve having a Shore A durometer hardness of from about 40 to about 60, the resilient grip positioned coaxially about the transducer and configured to reduce measured vibration acceleration at a grip surface of the resilient grip by a factor of at least about 2:1 relative to a rigid grip of similar geometry when tested according to ISO 5349-1 methodology;
at least two rotational conductors configured to electrically couple the at least two first contacts with at least two second contacts configured to connect to an ultrasonic drive system; and
a fluid connection rotatably coupled to the acoustic assembly,
wherein the resilient grip is configured to rotate the acoustic assembly relative to the fluid connection, the at least two second contacts, and a handpiece housing,
wherein a rotational interface of the rotation is located forward of a longitudinal center of the ergonomic ultrasonic dental scaling device, and
wherein tortional resistance applied to a user's hand is reduced during operation of the ergonomic ultrasonic dental scaling device.

2. The device of claim 1, wherein the acoustic assembly further comprises a preload mechanism configured to maintain a stack of piezoelectric crystals of the transducer under compressive force between a loading mass and the acoustic transformer.

3. The device of claim 1, wherein the resilient grip is configured to rotate the acoustic assembly at least 360 degrees relative to the fluid connection, the at least two second contacts, and the handpiece housing.

4. The device of claim 1, wherein the at least two rotational conductors includes four rotational conductors.

5. The device of claim 1, wherein the at least two rotational conductors are configured as concentric rings of different diameter.

6. The device of claim 1, wherein the rotational interface is located at an approximate midline of the handpiece housing.

7. The device of claim 1, wherein the rotational interface includes a bearing assembly configured to permit substantially frictionless rotation.

8. The device of claim 1, wherein the at least two rotational conductors are configured to provide electrical coupling between the at least two first contacts and the at least two second contacts while permitting continuous 360-degree rotation of the acoustic assembly relative to the handpiece housing.

9. The device of claim 1, wherein the fluid interface is configured to couple a pressurized water supply to the tip for cooling during operation.

10. The device of claim 1, wherein the resilient grip has an outer diameter of from about 10 mm to about 18 mm to facilitate ergonomic handling by a user.

11. The device of claim 1, wherein the resilient grip comprises layered elastomeric zones of varying durometer hardness to enhance vibration damping.

12. An ergonomic ultrasonic dental scaling device, comprising:
an acoustic assembly including an acoustic transformer configured to detachably receive a tip and a transducer coupled to the acoustic transformer and configured to produce ultrasonic vibrational energy;
a resilient grip having a substantially uniform cross-sectional configuration, wherein the resilient grip includes an elastomeric sleeve having a Shore A durometer hardness of from about 40 to about 60, the resilient grip positioned coaxially about the transducer and configured to reduce measured vibration acceleration at a grip surface of the resilient grip by a factor of at least about 2:1 relative to a rigid grip of similar geometry when tested according to ISO 5349-1 methodology;
at least two rotational conductors configured to electrically couple the transducer to an ultrasonic drive system; and
a fluid interface rotatably coupled to the acoustic assembly,
wherein a combination of the tip, the resilient grip, and the acoustic assembly are configured to rotate about an assembly axis relative to a handpiece housing while maintaining the electrical coupling between the transducer and the ultrasonic drive system the coupling between the fluid interface and the acoustic assembly, and
wherein tortional resistance applied to a user's hand is reduced during operation of the ergonomic ultrasonic dental scaling device.

13. The device of claim 12, wherein the acoustic assembly further comprises a preload mechanism configured to maintain a stack of piezoelectric crystals of the transducer under compressive force between a loading mass and the acoustic transformer.

14. The device of claim 12, wherein the at least two rotational conductors are configured to provide the electrical coupling while permitting continuous 360-degree rotation of the combination relative to the handpiece housing.

15. The device of claim 12, wherein the fluid interface is configured to couple a pressurized water supply to the tip for cooling during operation.

16. The device of claim 12, wherein the resilient grip has an outer diameter of from about 10 mm to about 18 mm to facilitate ergonomic handling by a user.

17. The device of claim 12, wherein the resilient grip area comprises layered elastomeric zones of varying durometer hardness to enhance vibration damping.

18. The device of claim 12, wherein the at least two rotational conductors includes four rotational conductors.

19. The device of claim 12, wherein the at least two rotational conductors are configured as concentric rings of different diameter.

20. The device of claim 12, wherein a rotational interface of the rotation is located at an approximate midline of the handpiece housing.

21. The device according of claim 12, wherein a rotational interface of the rotation comprises a bearing assembly configured to permit substantially frictionless rotation.

22. An ergonomic ultrasonic dental scaling device, comprising:
an acoustic assembly including an acoustic transformer configured to detachably receive a tip and a transducer coupled to the acoustic transformer and configured to produce ultrasonic vibrational energy in response to receipt of a drive signal from a signal source;
a handpiece housing;
a fluid reservoir disposed within the handpiece housing;
a spring-loaded reservoir cap configured to maintain a relatively uniform pressure on the fluid contained in the fluid reservoir;
a solenoid operably coupled to the fluid reservoir and configured to provide on-off control of fluid delivery, wherein the solenoid is electronically coupled to the signal source such that fluid delivery from the fluid reservoir is synchronized with a vibrational amplitude of the transducer;
a resilient grip having a substantially uniform cross-sectional configuration, wherein the resilient grip includes an elastomeric sleeve having a Shore A durometer hardness of from about 40 to about 60, the resilient grip positioned coaxially about the transducer and configured to reduce measured vibration acceleration at a grip surface of the resilient grip by a factor of at least about 2:1 relative to a rigid grip of similar geometry when tested according to ISO 5349-1 methodology;
at least two rotational conductors configured to electrically couple the transducer to an ultrasonic drive system; and
a fluid interface rotatably coupled to the acoustic assembly,
wherein a combination of the tip, the resilient grip, and the acoustic assembly is configured to rotate about a common axis relative to a handpiece housing,
wherein a rotational interface of the rotation is located forward of a longitudinal center of the ergonomic ultrasonic dental scaling device, and
wherein tortional resistance applied to a user's hand is reduced during operation of the ergonomic ultrasonic dental scaling device.

23. The device of claim 22, the acoustic assembly further comprises a preload mechanism configured to maintain a stack of piezoelectric crystals of the transducer under compressive force between a loading mass and the acoustic transformer.

23. The device of claim 22, wherein the at least two rotational conductors are configured to provide the electrical coupling while permitting continuous 360-degree rotation of the combination relative to the handpiece housing.

24. The device of claim 22, wherein the spring-loaded reservoir cap includes an elastomeric seal configured to prevent leakage during pressurization.

25. The device of claim 22, wherein the solenoid is configured to operate at a DC voltage of from about 12 volts to about 24 volts.

26. The device of claim 21, wherein the resilient grip includes an elastomeric material, wherein the elastomeric material is silicone, thermoplastic elastomer (TPE), or polyurethane.

27. The device of claim 22, wherein the resilient grip comprises layered elastomeric zones of varying durometer hardness to enhance vibration damping.

28. The device of claim 22, wherein the resilient grip area is configured to reduce hand-arm vibration exposure such that transmitted vibration acceleration from the acoustic assembly to a user is diminished by a factor of from about 2:1 to about 4:1.

29. The device of claim 22, wherein the resilient grip has an outer diameter of from about 10 mm to about 18 mm to facilitate ergonomic handling by a user.

30. The device according of claim 22, wherein a rotational interface of the rotation comprises a bearing assembly configured to permit substantially frictionless rotation.
